(19) United States
(12) Patent Application Publication
(10) Pub. No.: US 2020/0387882 A1
(43) Pub. Date: Dec. 10, 2020

(54) COMMODITY SALES DATA PROCESSING APPARATUS, CONTROL METHOD THEREFOR, AND DISPLAY CONTROL METHOD THEREOF

(71) Applicant: TOSHIBA TEC KABUSHIKI KAISHA, Tokyo (JP)

(72) Inventor: Ryouko MISHIMA, Izunokuni Shizuoka (JP)

(73) Assignee: TOSHIBA TEC KABUSHIKI KAISHA, Tokyo (JP)

(21) Appl. No.: 16/739,711

(22) Filed: Jan. 10, 2020

(30) Foreign Application Priority Data
Jun. 5, 2019 (JP) 2019-105589

(51) Int. Cl. G06Q 20/20; G06Q 30/02

(52) U.S. Cl. CPC G06Q 20/209; G06Q 30/0236; G06Q 30/0238; G06Q 20/201

(57) ABSTRACT

A commodity sales data processing apparatus includes a processing unit and a control unit. The processing unit processes sales data of a commodity that is bought and sold in a transaction. In a case of a transaction to which a privilege is not applied, the control unit outputs commodity data of the commodity whose sales data is processed by the processing unit to a first display device and a second display device. In a case of a transaction to which the privilege is applied, the control unit outputs the commodity data of the commodity whose sales data is processed by the processing unit to the first display device and outputs commodity data obtained by excluding items to which the privilege is applied among the commodity data of the commodity whose sales data is processed by the processing unit to the second display device.

### CROSS-REFERENCE TO RELATED APPLICATION

This application is based upon and claims the benefit of priority from Japanese Patent Application No. 2019-105589, filed on Jun. 5, 2019, the entire contents of which are incorporated herein by reference.

### FIELD

Embodiments described herein relate generally to a commodity sales data processing apparatus, a control method for causing a computer to function as the apparatus, and a display control method of the apparatus.

### BACKGROUND

In general, a commodity sales data processing apparatus such as a point of sales (POS) terminal is provided with a display device for customers in a store. On this display device, a commodity name, a price, and the like of a registered commodity are displayed. Accordingly, a customer can confirm from displayed information that the commodity to be purchased is correctly registered in the commodity sales data processing apparatus. However, a person who can confirm the displayed information is not limited to the customer who purchases the registered commodity. For example, there is a possibility that another customer who is waiting for payment alongside the customer can also confirm the displayed information.

Some stores employ an employee discount privilege system. This system is a system in which a commodity is discounted from a price of a price tag and sold to employees. Accordingly, when a customer who is a transaction target is an employee, an amount discounted from the price of the price tag is displayed on a customer display device. For that reason, when a customer other than employees sees the displayed contents, the customer may feel suspicious of the discounted amount.

### DESCRIPTION OF THE DRAWINGS

FIG. 1 is a block diagram illustrating a main circuit configuration of a POS terminal according to some embodiments;

FIG. 2 is a schematic diagram illustrating a main data structure of a commodity record stored in a commodity master file according to some embodiments;

FIG. 3 is a schematic diagram illustrating main memory areas formed in a main memory of the POS terminal according to some embodiments;

FIG. 4 is a table schematically illustrating a specific example of a display setting table according to the embodiment in FIG. 3;

FIG. 5 is a flowchart illustrating a processing procedure for one transaction executed by a processor of the POS terminal according to a control program according to some embodiments;

FIG. 6 is a flowchart illustrating the processing procedure for one transaction executed by the processor of the POS terminal continuing from FIG. 5;

FIG. 7 is a diagram illustrating an exemplary embodiment of a registration screen displayed on a first display in a case of a transaction to which an employee discount privilege system is not applied;

FIG. 8 is a diagram illustrating an exemplary embodiment of a registration screen displayed on a second display in the case of the transaction to which the employee discount privilege system is not applied;

FIG. 9 is a diagram illustrating an exemplary embodiment of a registration screen displayed on the first display in a case of a transaction to which the employee discount privilege system is applied;

FIG. 10 is a diagram illustrating an exemplary embodiment of a registration screen displayed on the second display in the case of the transaction to which the employee discount privilege system is applied;

FIG. 11 is a diagram illustrating an exemplary embodiment of a subtotal screen displayed on the first display in the case of the transaction to which the employee discount privilege system is applied; and

FIG. 12 is a diagram illustrating an exemplary embodiment of a subtotal screen displayed on the second display in the case of the transaction to which the employee discount privilege system is applied.

### DETAILED DESCRIPTION

Embodiments provide a commodity sales data processing apparatus that can eliminate a concern that a customer feels suspicious from the contents displayed on a display device.

In general, according to some embodiments, a commodity sales data processing apparatus includes a processor and a controller. The processor processes sales data of a commodity that is bought and sold in a transaction. In a case of a transaction to which a privilege is not applied, the controller outputs commodity data of the commodity whose sales data is processed by the processor to a first display device and a second display device. In a case of a transaction to which the privilege is applied, the controller outputs the commodity data of the commodity whose sales data is processed by the processor to the first display device and outputs commodity data obtained by excluding items to which the privilege (such as an employee discount or the like) is applied from the second display device.

Hereinafter, an embodiment of a commodity sales data processing apparatus that can eliminate a concern that a customer feels suspicious from the contents displayed on a display device will be described with reference to the drawings.

In this embodiment, an aspect of a commodity sales data processing apparatus is a point-of-sales (POS) terminal 10 used in a store where an employee discount privilege system is implemented.

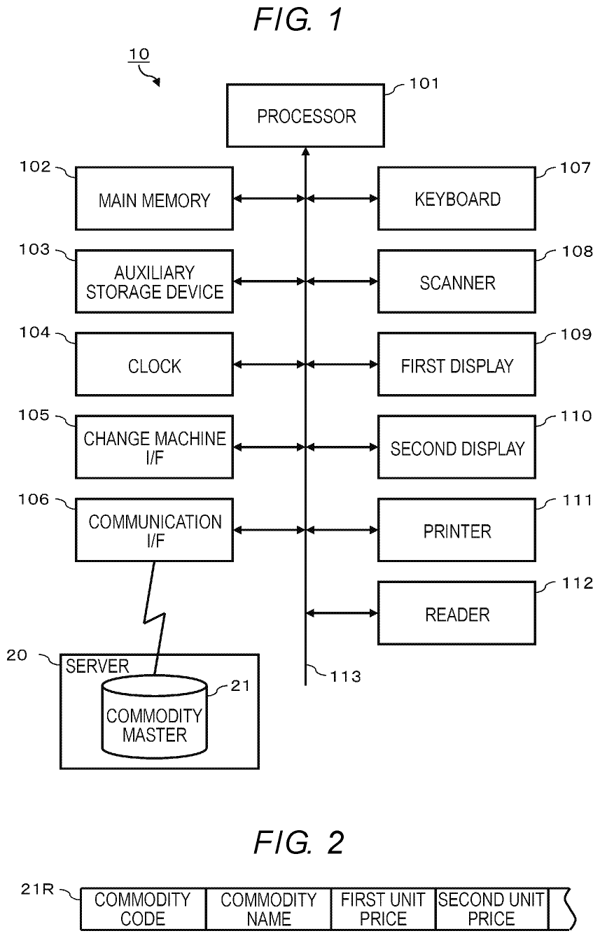

FIG. 1 is a block diagram illustrating a main circuit configuration of the POS terminal 10. The POS terminal 10 includes a processor 101, a main memory 102, an auxiliary storage device 103, a clock 104, a change machine interface 105, a communication interface 106, a keyboard 107, a scanner 108, a first display 109, a second display 110, a printer 111, a reader 112, and a system transmission path 113. The system transmission path 113 includes an address bus, a data bus, a control signal line, and the like. The system transmission path 113 connects the processor 101, the main memory 102, the auxiliary storage device 103, the clock 104, the change machine interface 105, the communication interface 106, the keyboard 107, the scanner 108, the first display 109, the second display 110, the printer 111, and the reader 112 to each other. A computer of the POS terminal 10 is configured by connecting the processor 101, the main memory 102, and the auxiliary storage device 103 through the system transmission path 113.

The processor 101 corresponds to a central processing unit (CPU) of the computer. The processor 101 controls each unit to implement various functions as the POS terminal 10 according to an operating system or an application program.

The main memory 102 corresponds to a main memory portion of the computer. The main memory 102 includes a non-volatile memory area and a volatile memory area. The main memory 102 stores the operating system or the application program in the non-volatile memory area. The main memory 102 may store data necessary for the processor 101 to execute processing for controlling each unit in the non-volatile memory area volatile memory area. The main memory 102 uses the volatile memory area as a work area in which data is appropriately rewritten by the processor 101. The non-volatile memory area is, for example, a read only memory (ROM). The volatile memory area is, for example, a random access memory (RAM).

The auxiliary storage device 103 corresponds to an auxiliary storage portion of the computer. For example, an electric erasable programmable read-only memory (EEPROM), a hard disc drive (HDD), a solid state drive (SSD), or the like can be the auxiliary storage device 103. The auxiliary storage device 103 stores data used when the processor 101 performs various processes, data generated by the processes in the processor 101, and the like. The auxiliary storage device 103 may store the application program described above.

The application program stored in the main memory 102 or the auxiliary storage device 103 includes a control program described regarding information processing executed in the POS terminal 10. In can be appreciated that a method for installing the control program in the main memory 102 or the auxiliary storage device 103 is not particularly limited. The control program can be installed in the main memory 102 or the auxiliary storage device 103 by being recorded on a removable recording medium, or distributed by communication via a network. The recording medium may be in any form as long as it can store a program and can be read by the apparatus, such as a CD-ROM or a memory card.

The clock 104 functions as a time information source for the POS terminal 10. The processor 101 records the current date and time based on the time information recorded by the clock 104.

The change machine interface 105 communicates with an automatic change machine. The change machine interface 105 receives data of an input amount of money, data of a number of stored money, and the like from the automatic change machine. The change machine interface 105 calculates and transmits change data to the automatic change machine.

The communication interface 106 performs data communication with a store server 20 connected via a network such as a wired local area network (LAN) or a wireless LAN. The store server 20 includes a commodity master file 21. The commodity master file 21 may be formed in a storage device built in the store server 20, or may be formed in a storage device connected to the outside of the store server 20.

As seen in FIG. 2, the commodity master file 21 stores a commodity record 21R that is generated for each commodity. A main data structure of the commodity record 21R is illustrated in the schematic diagram of FIG. 2. The commodity record 21R includes commodity data such as a commodity code, a commodity name, a first unit price, and a second unit price.

The commodity code is a unique code set for each commodity in order to identify each commodity. In general, a barcode symbol or a two-dimensional data code symbol obtained by converting the commodity code into each symbol, respectively, is attached to each commodity. Alternatively, a radio frequency identification (RFID) tag storing the commodity code may be attached thereto. The POS terminal 10 can register the sales data of the commodity by reading the barcode symbol, the two-dimensional data code symbol or RFID tag data with a reading device, such as the scanner 108 or the like.

The commodity name is a name of the commodity specified by the commodity code, and the first unit price is a price per unit of the commodity. In general, the first unit price is written together with the commodity name on the price tag of the commodity displayed on the sales floor. The second unit price is an amount discounted from the first unit price, obtained by applying a discount by the employee discount privilege system. The second unit price may be the same amount as the first unit price depending on the commodity, for example in a case where certain commodities are not eligible for discount.

The keyboard 107 and the scanner 108 function as input devices for inputting information related to transactions.

The keyboard 107 is a keyboard dedicated to the POS terminal 10 on which a ten-key, a clear key, a multiplication key, a subtotal key, a deposit and current total key, a credit key, an electronic money key, and the like are arranged. The deposit and current total key is a key for declaring closing of a transaction by cash payment. The credit key is a key for declaring closing of the transaction by credit card payment. The electronic money key is a key for declaring closing of the transaction by electronic money payment. The deposit and current total key, credit key, and electronic money key are generally referred to as a closing key. The keyboard 107 may be one in which functions such as the clear key, the multiplication key, the subtotal key, and the deposit and current total key are assigned to function keys of a general-purpose keyboard having the ten-key.

The scanner 108 reads a code symbol such as a barcode or a two-dimensional data code attached to a commodity. The scanner 108 may be a type of scanner that reads the code symbol by scanning with a laser beam, or may be a type of scanner that reads the code symbol from an image captured by an image-capturing device.

The first display 109 and the second display 110 are both display devices for displaying commodity data. The commodity data is composed of items such as the commodity name, unit price, number of units, amount, total units, and total amount. The commodity data may include other items.

The first display 109 is a display device for an employee who is an operator of the POS terminal 10 (i.e., a cashier). For that reason, the first display 109 is provided at a position where the cashier can see the first display. The second display 110 is a display device for a customer who performs payment at the POS terminal 10. For that reason, the second display 110 is provided at a position where the customer can see the second display. Here, the first display 109 functions as the first display device and the second display 110 functions as the second display device. Types of display devices may include, for example, a liquid crystal display, an organic electroluminescence (EL) display, or the like. Touch panels may be used in the first display 109 and the second display 110.

The printer 111 prints various character strings or images on receipt paper. The printer 111 cuts printed receipt paper and issues a receipt. Types of printers 111 may include, for example, a thermal printer or a dot impact printer can be used. The receipt is not limited to a paper receipt printed on receipt paper. The receipt may be an electronic receipt obtained by digitizing data printed on a paper receipt.

The reader 112 is a device having a function of reading data recorded on a medium such as a card or a smartphone. The reader 112 may be a reader and writer having a function of writing data on the medium. The card may be a user card such as a membership card or employee card, in addition to a settlement card such as a credit card or an electronic money card.

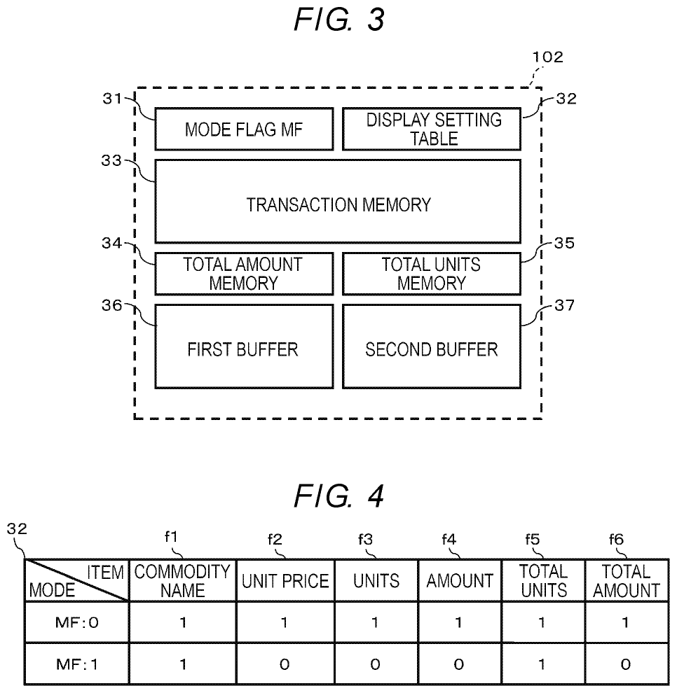

As illustrated in FIG. 3, in the POS terminal 10 having such a configuration, areas of a flag memory 31 of a mode flag MF, a display setting table 32, a transaction memory 33, a total amount memory 34, a total units memory 35, a first buffer 36, and a second buffer 37 are formed in a volatile area of the main memory 102.

A mode flag M1 stored in the flag memory 31 is 1-bit data for identifying whether or not it is a transaction to which the employee discount privilege system is applied. Each employee has an employee card in which a unique employee code is recorded. When the employee code is read from the employee card via the reader 112, the processor 101 recognizes that it is the transaction to which the employee discount privilege system is applied. In this embodiment, the mode flag MF is “1” in a case of a transaction to which the employee discount privilege system is applied and is “0” in a case of the transaction to which the employee discount privilege system is not applied.

The display setting table 32 is a data table having a data structure as illustrated in FIG. 4. That is, in the display setting table 32, display flags f1, f2, f3, f4, f5, and f6 that respectively correspond to the items of commodity name, unit price, units, amount, total units, and total amount are set for each value of the mode flag MF. The display flags f1 to f6 are 1-bit data for identifying whether or not to display the commodity data of the item in a case of a transaction having a value corresponding to the mode flag MF. In this embodiment, the display flags f1 to f6 of items to be displayed are “1”, and the display flags f1 to f6 of items not to be displayed are “0”. In the example of the display flags f1 to f6 illustrated in FIG. 4, in a transaction wherein the mode flag MF is “0”, that is, the employee discount privilege is not applied, the display items include commodity name, unit price, units, amount, total units, and total amount. In a transaction wherein the mode flag MF is “1”, that is, the employee discount privilege is applied, the display items include the commodity name and the total units.

The transaction memory 33 is an area for storing commodity sales data registered in the POS terminal 10 as a single transaction. The commodity sales data is composed of a commodity code, a commodity name, a number of units, an amount, total units, and a total amount. The total amount memory 34 is an area for totaling the amounts of commodity sales data registered in the transaction memory 33. The total units memory 35 is an area for totaling the units of commodity sales data registered in the transaction memory 33.

The first buffer 36 is an area for storing data to be displayed on the first display 109. The second buffer 37 is an area for storing data to be displayed on the second display 110. The processor 101 generates screen data to be displayed on the first display 109 based on the data stored in the first buffer 36. Similarly, the processor 101 generates screen data to be displayed on the second display 110 based on the data stored in the second buffer 37.

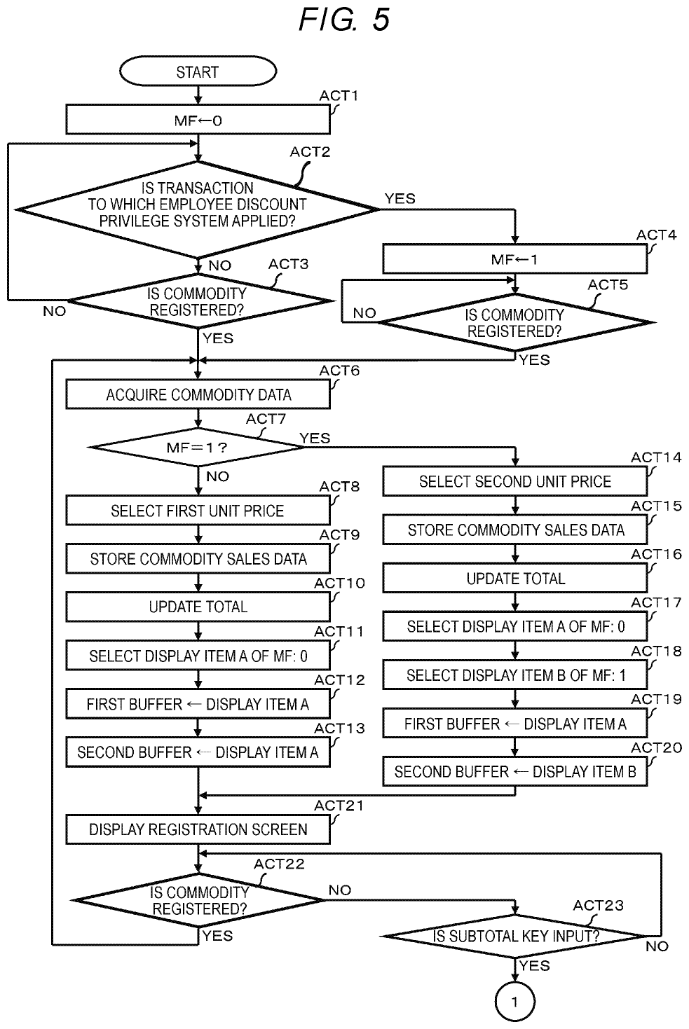

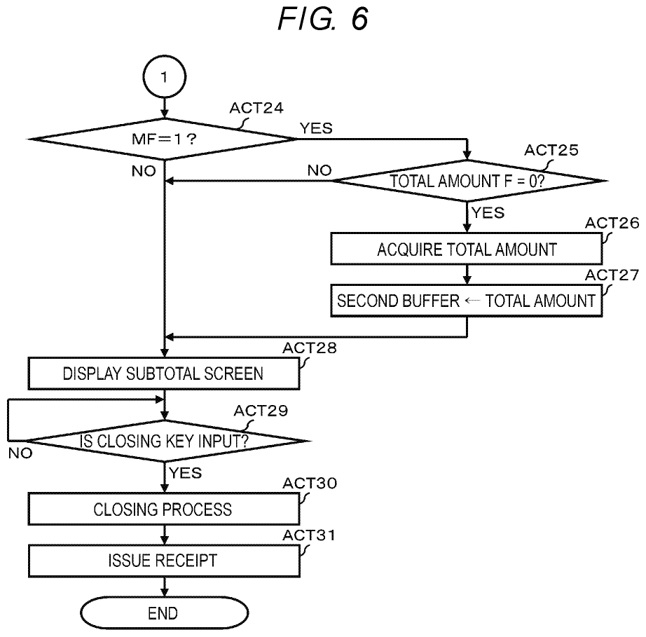

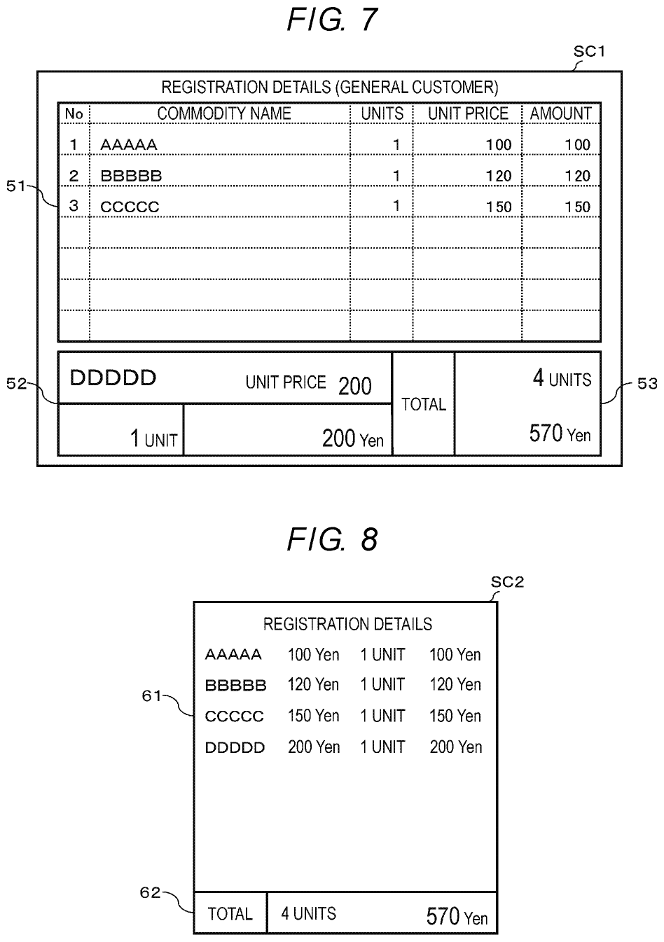

FIGS. 5 and 6 are flowcharts illustrating a processing procedure for one transaction executed by the processor 101 according to a control program. FIGS. 7 to 12 are examples of images displayed on the first display 109 and the second display 110 based on a process having the processing procedure. Hereinafter, an operation of the POS terminal 10 will be described with reference to these drawings as appropriate. The procedure and contents of the operation are described below according to exemplary embodiments. The procedure and contents are not particularly limited if similar results can be obtained with a different order of operations or components.

The processor 101 first sets the mode flag MF of the flag memory 31 to “0”, as ACT 1. That is, the POS terminal 10 defaults to a transaction to which the employee discount privilege system is not applied.

In this state, the processor 101 confirms whether or not a transaction in which the employee discount privilege system is applied is declared, as ACT 2. Responsive to confirming that such a declaration is not made, the processor 101 determines that the determination result in ACT 2 is NO, and proceeds to ACT 3. The processor 101 confirms whether or not commodity registration is performed, as ACT 3. Responsive to confirming that the commodity registration is not performed, the processor 101 determines that the determination result in ACT 3 is NO, and returns to ACT 2. Thus, after initializing the mode flag MF to “0”, the processor 101 waits for declaration of the transaction to which the employee discount privilege system is applied or for performance of commodity registration of the first commodity.

When the employee card data is read by the reader 112 in this waiting state, the processor 101 recognizes that the transaction to which the employee discount privilege system is applied is declared. The processor 101 determines that the determination result in ACT 2 is YES, and proceeds to ACT 4. The processor 101 sets the mode flag MF of the flag memory 31 to “1”, as ACT 4. Thereafter, the processor 101 waits for performance of the commodity registration, as ACT 5.

When the code symbol including the commodity code is read by the scanner 108, the processor 101 performs commodity registration is performed. Alternatively, the processor 101 can perform commodity registration when the commodity code is input via the keyboard 107. Upon determining that the commodity registration is complete, the processor 101 determines the result in ACT 3 or ACT 5 is YES, and proceeds to ACT 6.

The processor 101 acquires commodity data from the store server 20, as ACT 6. That is, the processor 101 controls the communication interface 106 to transmit a commodity data inquiry command to the store server 20. The inquiry command is then transmitted from the communication interface 106 to the store server 20. The inquiry command includes the commodity code.

The store server 20 receives the inquiry command, retrieves the commodity master file 21, and reads the commodity record 21R including the commodity code in the inquiry command. Then, the store server 20 transmits the commodity data of the commodity record 21R to the POS terminal 10. The POS terminal 10 receives the commodity data at the communication interface 106, which then transmits the inquiry command. Thus, the processor 101 can acquire the commodity data.

The processor 101 which acquires the commodity data checks the mode flag MF, as ACT 7. When the mode flag MF is set to “0”, the processor 101 determines the result in ACT 7 is NO, and proceeds to ACT 8. The processor 101 selects a first unit price from the commodity data, as ACT 8. The processor 101 calculates the amount by multiplying the first unit price by the number of units; generates commodity sales data from the commodity code, the commodity name, and the first unit price of the commodity data; and stores the commodity sales data in the transaction memory 33 as ACT 9. The number of units is a multiplier when input with the ten-key and multiplication key of the keyboard 107 before the commodity code is input, and is “1” when a multiplier is not input.

The processor 101 adds the amount of the commodity sales data to the total amount memory 34 and adds the units to the total units memory 35, as ACT 10.

The processor 101 refers to the display setting table 32, as ACT 11. Then, the processor 101 selects an item A of a display flag which is set to “1” among the display flags corresponding to the mode flag MF of “0”. That is, in the setting example of FIG. 4, the processor 101 selects the commodity name, unit price, number of units, amount, total units, and total amount, as the display item A.

The processor 101 stores the commodity data of the display item A in the first buffer 36, as ACT 12. The processor 101 also stores the commodity data of the display item A in the second buffer 37, as ACT 13.

On the other hand, when the mode flag MF is set to “1”, the processor 101 determines that the determination result in ACT 7 is YES, and proceeds to ACT 14. The processor 101 selects the second unit price from the commodity data, as ACT 14. Then, the processor 101 calculates the amount by multiplying the second unit price by the number of units, as ACT 15, generates the commodity sales data composed of the commodity code, commodity name, second unit price, units, and amount of the commodity data, and stores the commodity sales data in the transaction memory 33.

The processor 101 adds the amount of the commodity sales data to the total amount memory 34 and adds the units to the total units memory 35, as ACT 16.

The processor 101 references the display setting table 32, as ACT 17 and selects the item A of the display flag which is set to “1” among the display flags corresponding to the mode flag MF of “0”. That is, in the example of FIG. 4, the processor 101 selects the commodity name, the unit price, the units, the amount, the total units, and the total amount, as the display item A.

The processor 101 selects an item B of the display flag which is set to “1” among the display flags corresponding to the mode flag MF of “1”, as ACT 18. That is, in the setting example of FIG. 4, the processor 101 selects the commodity name and the total units as the display item B.

The processor 101 stores the commodity data of the display item A in the first buffer 36, as ACT 19. The processor 101 stores the commodity data of the display item B in the second buffer 37, as ACT 20.

As such, when the commodity registration is performed, the processor 101 acquires the commodity data of the commodity. The processor 101 executes processes ACT 8 to ACT 13 when the mode flag MF is “0”. That is, the processor 101 generates commodity sales data using the first unit price of the commodity data and registers the commodity sales data in the transaction memory 33. The processor 101 selects the commodity data of the display item A and stores the commodity data in the first buffer 12 and the second buffer 13, respectively.

When the mode flag MF is “1”, the processor 101 executes processes ACT 14 to ACT 20. That is, the processor 101 generates commodity sales data using the second unit price of the commodity data, and registers the commodity sales data in the transaction memory 33. The processor 101 stores the commodity data of the display item A in the first buffer 12 and stores the commodity data of the display item B in the second buffer 13.

Responsive to determining completion of ACT 13 or ACT 20, the processor 101 displays the registration screen on each of the first display 109 and the second display 110 as ACT 21. That is, the processor 101 generates registration screen data for the first display 109 based on data stored in the first buffer 36 and outputs the registration screen data to the first display 109. Similarly, the processor 101 generates registration screen data for the second display based on data stored in the second buffer 37 and outputs the registration screen data to the second display 110.

In ACT 9 and ACT 15, the computer including processor 101 of the POS terminal 10 configures a processing unit for processing sales data (sales processor) of the commodities bought and sold in transactions.

The computer of the POS terminal 10 configures a control unit for the display (display controller) by the processes ACT 11 to ACT 13, and ACT 17 to ACT 21. That is, the computer of the POS terminal 10 outputs the commodity data of the display item A to the first display 109 and the second display 110 in the case of a transaction to which no privilege is applied. In the case of a transaction to which a privilege is applied, the commodity data of the display item A is output to the first display 109 and the commodity data of the display item B is output to the second display 110.

The commodity data of the display item A is the commodity name, price (first unit price or second unit price), number of units, amount, total units, and total amount of the commodity whose the sales data is processed by the sales processor. The commodity data of the display item B is the commodity name and total amount of the commodity whose sales data is processed by the sales processor. The second unit price, which is the price of the commodity, is excluded from the display item B because the second unit price is an item to which the privilege is applied. Similarly, the units, the amount, and the total amount thereof are also excluded from the display item B because the units, the amount, and the total amount thereof are items with which the second unit price can be calculated.

Responsive to determining that the display controller has completed display of the registration screen, the processor 101 confirms whether or not a new commodity registration is performed, as ACT 22. When it is confirmed that the commodity registration is not performed, the processor 101 confirms whether or not a subtotal key is input, as ACT 23. When it is confirmed that the subtotal key is not input, the processor 101 determines the result in ACT 23 is NO and returns to ACT 22. As such, the processor 101 waits for performance of new commodity registration or for input of the subtotal key, as ACT 22 and ACT 23. When another input is made in this waiting state, the processor 101 executes a process according to the input. Then, the processor 101 returns to the waiting state of ACT 22 and ACT 23 again. In this way, the computer of the POS terminal 10 configures a reception unit (receiver) for receiving a subtotal output of commodities bought and sold in transactions.

When the commodity registration is performed in the waiting state of ACT 22 and ACT 23, the processor 101 determines the result in ACT 22 is NO and returns to ACT 6. Then, the processor 101 executes the process of ACT 6 and subsequent processes similarly as described above.

When the subtotal key is input in the waiting state of ACT 22 and ACT 23, the processor 101 determines the result in ACT 23 is YES and proceeds to ACT 24 in FIG. 6. The processor 101 checks the mode flag MF, as ACT 24. When the mode flag MF is “0”, the processor 101 determines the result in ACT 24 is NO and proceeds to ACT 28.

When the mode flag MF is “1”, the processor 101 retrieves the display setting table 32, as ACT 25. Then, the processor 101 confirms whether or not the display flag corresponding to the item “total amount” when the mode flag F is “1” is “0”. When it is determined that the display flag corresponding to the item “total amount” is “1”, the processor 101 determines the result in ACT 25 is NO and proceeds to ACT 28.

When it is determined that the display flag corresponding to the item “total amount” is “0”, the processor 101 determines the result in ACT 25 is YES and proceeds to ACT 26. The processor 101 acquires the total amount from the total amount memory 34, as ACT 26. Then, the processor 101 stores data of the total amount in the second buffer 37, as ACT 27. Thereafter, the processor 101 proceeds to ACT 28.

The processor 101 causes each of the first display 109 and the second display 110 to display a subtotal screen, as ACT 28. That is, the processor 101 generates subtotal screen data for the first display 109 based on the data stored in the first buffer 36. Then, the processor 101 outputs the subtotal screen data to the first display 109. Similarly, the processor 101 generates subtotal screen data for the second display based on the data stored in the second buffer 37. Then, the processor 101 outputs the subtotal screen data to the second display 110.

Here, when the subtotal output is received by the processes of ACT 24 to ACT 28, the computer of the POS terminal 10 having the processor 101 executes a function of excluding the total amount from items to which the privileges are applied.

Responsive to determining that the display controller has completed display of the subtotal screen, the processor 101 waits for input of a closing key, as ACT 29. When the commodity registration is performed in this waiting state, the processor 101 returns to ACT 6, performs the processes of ACT 6 to ACT 28 similarly as described above, and returns to the waiting state of ACT 29 for the input of the closing key.

When the closing key such as a deposit and current total key, a credit key, or an electronic money key is input, the processor 101 determines the result in ACT 29 is YES and proceeds to ACT 30. The processor 101 executes the closing process in ACT 30. That is, when the deposit and current total key is input, the processor 101 executes a closing process by cash transaction. When the credit key is input, the processor 101 executes a closing process by credit card transaction. When the electronic money key is input, the processor 101 executes a closing process by electronic money transaction. Since these closing processes are well-known processes, a description thereof is omitted here.

Upon determining that the closing process is completed, the processor 101 controls issuance of a receipt, as ACT 31. That is, the processor 101 generates receipt data based on the data in the transaction memory 33, the total amount memory 34, and the total units memory 35. The processor 101 outputs the receipt data to the printer 111. The printer 111 prints the receipt data on receipt paper to issue a receipt, and the processor 101 ends a process of one transaction.

FIG. 7 is an exemplary embodiment of a registration screen SC1 displayed on the first display 109 in the case of the transaction to which the employee discount privilege system is not applied, and FIG. 8 is an exemplary embodiment of a registration screen SC2 displayed on the second display 110 in the case of the transaction. That is, FIG. 7 and FIG. 8 display examples of the registration screen SC1 and the registration screen SC2 of a transaction in which a general customer other than an employee purchases four commodity items of a commodity “AAAAA” with a first unit price of 100 yen, a commodity “BBBBB” with a first unit price of 120 yen, a commodity “CCCCC” with a first unit price of 150 yen, and a commodity “DDDDD” with a first unit price of 200 yen.

As illustrated in FIG. 7, the registration screen SC1 on the first display 109 is divided into a detail area 51, a latest area 52, and a total area 53. In the detail area 51, the names, units, first unit prices, and amounts of the commodities “AAAAA”, “BBBBBB”, and “CCCCC” from the first commodity to the third commodity are displayed from the left toward the screen. In the latest area 52, the name and first unit price of the fourth commodity “DDDDD” (e.g., the latest registered commodity) are displayed in the upper part, and the units and amount thereof are displayed in the lower part. In the total area 53, the total units and total amount are displayed vertically. As such, on the registration screen SC1, the items for which the display flag is set to “1” while the mode flag MF is “0”, that is, the commodity name, the unit price, the units, the amount, the total units, and the total amount are displayed.

As illustrated in FIG. 8, the registration screen SC2 on the second display 110 is divided into a detail area 61 and a total area 62. In the detail area 61, the names, first unit prices, units, and amounts of the commodities “AAAAA”, “BBBBB”, “CCCCC”, and “DDDDD” from the first commodity to the fourth commodity are displayed from the left toward the screen. In the total area 62, the total units and the total amount are displayed from the left toward the screen. As such, on the registration screen SC2, the items for which the display flag is set to “1” while the mode flag MF is “0”, that is, the commodity name, the unit price, the units, the amount, the total units, and the total amount are displayed.

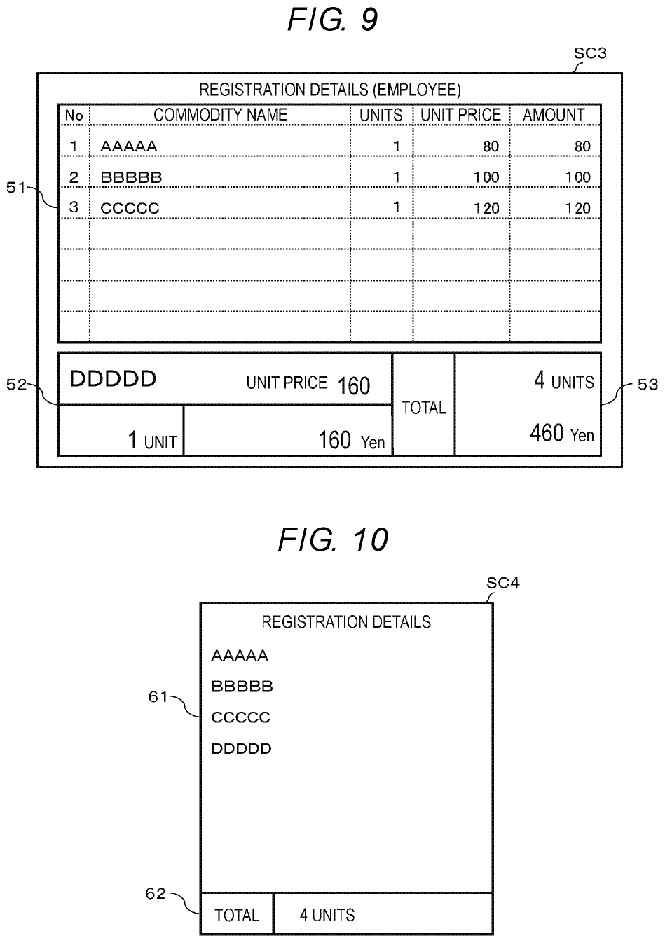

FIG. 9 is an exemplary embodiment of a registration screen SC3 displayed on the first display 109 in the case of the transaction to which the employee discount privilege system is applied, and FIG. 10 is an exemplary embodiment of a registration screen SC4 displayed on the second display 110 in the case of the transaction. That is, FIG. 9 and FIG. 10 display examples of the registration screen SC1 and the registration screen SC2 of a transaction in which an employee purchases four commodity items of the commodity “AAAAA” with a second unit price of 80 yen, the commodity “BBBBB” with a second unit price of 100 yen, the commodity “CCCCC” with a first unit price of 120 yen, and the commodity “DDDDD” with a first unit price of 160 yen. That is, the commodities purchased by the employee are the same as those of the general customer described with reference to FIGS. 7 and 8.

As illustrated in FIG. 9, the registration screen SC3 on the first display 109 is divided into the detail area 51, the latest area 52, and the total area 53. In the detail area 51, the names, units, second unit prices, and amounts of the commodities “AAAAA”, “BBBBBB”, and “CCCCC” from the first commodity to the third commodity are displayed from the left toward the screen. In the latest area 52, the name and second unit price of the fourth commodity “DDDDD” (e.g., the latest registered commodity) are displayed in the upper part, and the units and amount thereof are displayed in the lower part. In the total area 53, the total units and total amount are displayed vertically. The items for which the display flag is set to “1” while the mode flag MF is “0”, that is, the commodity name, the unit price, the units, the amount, the total units, and the total amount are displayed on the registration screen SC1.

As illustrated in FIG. 10, the registration screen SC4 on the second display 110 is divided into the detail area 61 and the total area 62. In the detail area 61, only the names of commodities “AAAAA”, “BBBBB”, “CCCCC”, and “DDDDD” from the first commodity to the fourth commodity are displayed. In the total area 62, only the total units are displayed. The items for which the display flag is set to “1” while the mode flag MF is “1”, that is, the commodity name and the total units, are displayed on the registration screen SC4.

The registration screen SC2 in FIG. 8 and the registration screen SC4 in FIG. 10 are both displayed on the second display 110. Therefore, the contents displayed on the registration screen SC2 and the registration screen SC4 can be seen not only by a customer who is a transaction target but also by a customer who is not a transaction target. The unit price of the commodity displayed on the registration screen SC2 is the first unit price, which is the price written on the price tag of the commodity. Accordingly, even if a customer who is not the transaction target sees the registration screen SC2, the customer does not feel suspicious of the displayed price.

On the registration screen SC4, the unit price of the commodity with the discount applied, that is, the second unit price, is not displayed. Accordingly, even if the customer who is not the transaction target sees the registration screen SC4, the customer does not feel suspicious that the price displayed on the screen is lower than the price written on the price tag. Therefore, the concern that the customer feels suspicious from the contents displayed on the second display 110 is eliminated. On the other hand, since the commodity name and the total units are displayed on the registration screen SC4, the employee who is the transaction target can recognize that the commodity to be purchased is correctly registered in the POS terminal 10.

Both the registration screen SC1 of FIG. 7 and the registration screen SC3 of FIG. 9 are displayed on the first display 109. Accordingly, only the cashier who is the operator of the POS terminal 10 can see the contents displayed on the registration screen SC1 and the registration screen SC3. Customers, including a customer who is the transaction target, cannot see the registration screen SC1 or the registration screen SC3. Therefore, there is no concern that the customer may feel suspicious from the contents displayed on the first display 109. On the other hand, the cashier can easily confirm from the contents displayed on the registration screen SC3 that the transaction to which the employee discount privilege system is applied is correctly registered in terms of the second unit price. Accordingly, a cashier's business is not hindered.

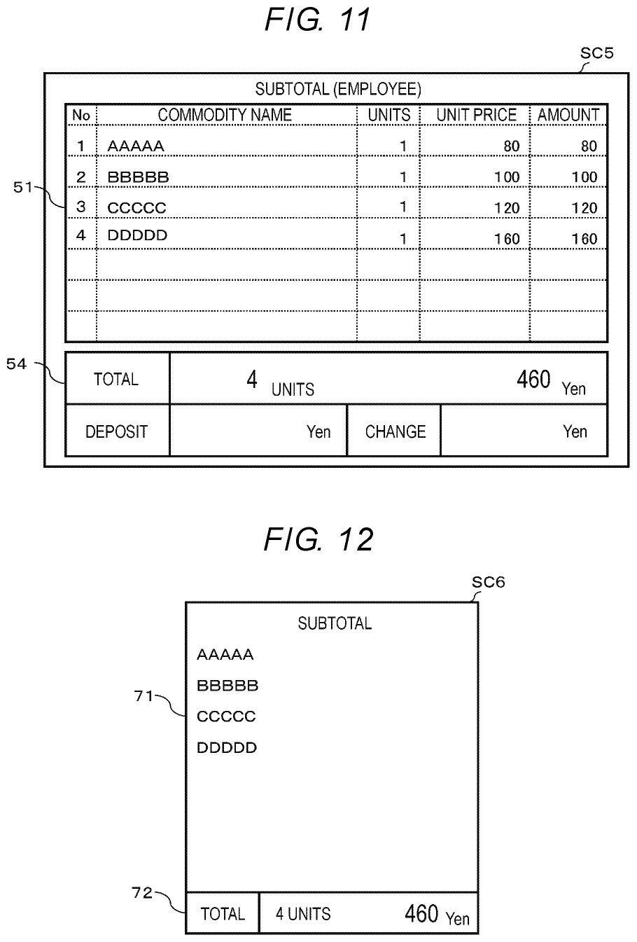

FIG. 11 and FIG. 12 are exemplary embodiments of subtotal screens SC5 and SC6 when the subtotal key is input after the registration screens SC3 and SC4 of FIG. 9 or FIG. 10 are displayed. That is, FIG. 11 is an example of the subtotal screen SC5 displayed on the first display 109, and FIG. 12 is an example of the subtotal screen SC6 displayed on the second display 110.

As illustrated in FIG. 11, the subtotal screen SC5 on the first display 109 is obtained by arranging a closing area 54 instead of the latest area 52 and the total area 53 of the registration screen SC3. In the closing area 54, the total units and the total amount are displayed in the upper part. The lower part of the closing area 54 is a display area for deposit amount and change amount. The commodity name, units, unit price, and amount of the commodity “DDDDD” displayed in the latest area 52 of the registration screen SC3 are added to the detail area 51.

As illustrated in FIG. 12, the subtotal screen SC6 on the second display 110 is divided into a detail area 71 and a total area 72, similarly as in the registration screen SC4 of FIG. 10. In the detail area 71, only the commodity names of the registered commodities are displayed, similarly as in the registration screen SC4. In contrast, in the total area 72, the total amount is newly displayed in addition to the total units.

As such, after the subtotal key is input, the total amount is displayed on the second display 110. Accordingly, since the employee who is the transaction target only has to pay an amount of money for the total amount, the employee can easily know the payment amount. On the other hand, even if a customer who is not the transaction target sees the subtotal screen SC6 displayed on the second display 110, the possibility that the customer feels suspicious that the total amount displayed in the total area 72 is different from the amount obtained by totaling the price tags of the commodities whose commodity names are displayed in the detail area 71 is extremely low. Accordingly, the effect of eliminating the concern that the customer feels suspicious from the contents displayed on the second display 110 can also be achieved on the subtotal screen SC6.

Thus, the embodiment of the commodity sales data processing apparatus can eliminate the concern that the customer feels suspicious from the contents displayed on the display device is described, but is not limited to thereto.

According to some embodiments, when the processor 101 reads the employee code from the employee card via the reader 112, the processor 101 recognizes that the transaction is the transaction to which the employee discount privilege system is applied. In this regard, for example, when an employee transaction declaration key is placed on the keyboard 107 and this declaration key is input, the processor 101 may recognize that the transaction is the transaction to which the employee discount privilege system is applied.

According to some embodiments, a case where the items displayed on the second display 110 are restricted when the transaction is the transaction to which the employee discount privilege system is applied is illustrated. In this regard, the items displayed on the second display 110 may be restricted in a transaction to which a privilege system other than employee discount is applied. For example, if there is a privilege system in which commodities are sold at a discounted price than the price listed on the price tag for a preferential customer, by restricting the items displayed on the second display 110 when performing transaction with the preferential customer, the same operational effects as those in the embodiment described above can be achieved.

In the case of the transaction to which the privilege system is applied, items that are restricted from being displayed on the second display 110 are not limited to the unit price, the units, the amount, and the total amount. For example, the unit price and the amount are not displayed, but the units and the total amount may be displayed. Instead of setting the second unit price for each commodity, a uniform discount rate may be set for transactions to which the privilege system is applied. In this case, the price of the commodity purchased by the privilege target person is calculated from the unit price of the commodity and the discount rate. Therefore, in the case of the transaction to which the privilege system is applied, the discounted price or the discount amount is set as a restriction item that is not displayed on the second display 110. By doing as described above, the concern that the customer feels suspicious from the contents displayed on the display device is eliminated.

The second display 110 is not limited to the display device provided in the POS terminal 10. The second display 110 may be a display device provided in an information terminal such as a smartphone or a tablet terminal owned by the customer. Alternatively, the second display 110 may be a display device of an information terminal provided in a shopping cart. In this case, the second display 110 displays data of the commodity output from the commodity sales data processing apparatus such as the POS terminal 10 and received by the information terminal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity sales data processing apparatus comprising:
a processor configured to:
register commodity data from sales data of at least one commodity of a plurality of commodities that are bought and sold in a transaction, and
determine whether a privilege is applied to the transaction; and
a controller configured to:
responsive to determining that the privilege is not applied to the transaction, output commodity data of the at least one commodity whose sales data is processed to a first display device and a second display device, and
responsive to determining that the privilege is applied to the transaction, output commodity data of the at least one commodity whose sales data is processed to the first display device and output commodity data obtained by excluding the at least one commodity to which the privilege is applied among the plurality of commodities whose sales data is processed to the second display device.

2. The apparatus according to claim 1, wherein
the commodity data comprises a commodity name and a first unit price of the at least one commodity, and the privilege is applied to the first unit price to determine a second unit price lower than the first unit price.

3. The apparatus according to claim 1, wherein
the commodity data comprises a commodity name, a first unit price, and a total amount of the at least one commodity whose sales data is processed, and the privilege is applied to the first unit price and the total amount.

4. The apparatus according to claim 3, wherein the processor is further configured to:
receive a subtotal amount of the plurality of commodities bought and sold in the transaction; and
exclude from the subtotal amount the total amount from the at least one commodity to which the privilege is applied.

5. The apparatus according to claim 1, wherein the first display device is disposed such that a screen of the first display device is visible to an operator of a Point of Sales terminal.

6. The apparatus according to claim 1, wherein the second display device is disposed such that a screen of the second display device is visible to a customer.

7. A control method for controlling a commodity sales data processing apparatus comprising:
registering, at a processor, sales data of at least one commodity of a plurality of commodities that are bought and sold in a transaction;
determining, at the processor, whether a privilege is applied to the transaction;
outputting, by a controller responsive to determining that the privilege is not applied to the transaction, commodity data of the at least one commodity whose sales data is processed to a first display device and a second display device; and
outputting, by the controller responsive to determining that the privilege is applied to the transaction, commodity data of the at least one commodity whose sales data is processed to the first display device and commodity data obtained by excluding commodity data of the at least one commodity to which the privilege is applied from the commodity data of the plurality of commodities whose sales data is processed to the second display device.

8. The control method according to claim 9, wherein
the commodity data comprises a commodity name and a first unit price of the at least one commodity, and the privilege is applied to the first unit price to determine a second unit price lower than the first unit price.

9. The control method according to claim 9, wherein
the commodity data comprises a commodity name, a first unit price, and a total amount of the at least one commodity whose sales data is processed, and the privilege is applied to the first unit price and the total amount.

10. The control method according to claim 11, further comprising:
receiving, at the processor, a subtotal amount of the plurality of commodities bought and sold in the transaction; and
excluding from the subtotal amount the total amount of the at least one commodity to which the privilege is applied.

11. A display control method of a commodity sales data processing apparatus for processing sales data of a commodity that is bought and sold in a transaction, the method comprising:
outputting, by a processor responsive to determining that a privilege is not applied to the transaction, commodity data of the commodity whose sales data is processed to a first display device and a second display device; and
outputting, by a processor responsive to determining that a privilege is applied to the transaction, the commodity data of the commodity whose sales data is processed to the first display device and commodity data obtained by excluding the at least one commodity to which the privilege is applied from the commodity data of the plurality of commodities whose sales data is processed to the second display device.

12. The display control method according to claim 13, wherein
the commodity data comprises a commodity name and a first unit price of the at least one commodity, and the privilege is applied to the first unit price to determine a second unit price lower than the first unit price.

13. The display control method according to claim 13, wherein
the commodity data comprises a commodity name, a first unit price, and a total amount of the at least one commodity whose sales data is processed, and the privilege is applied to the first unit price and the total amount.

14. The display control method according to claim 15, further comprising:
receiving, at the processor, a subtotal amount of the plurality of commodities bought and sold in the transaction;
excluding from the subtotal amount the total amount of the at least one commodity to which the privilege is applied;
displaying, on the first display device, the total amount of the at least one commodity to which the privilege is applied; and
displaying, on the second display device, the subtotal amount.

15. The display control method according to claim 13, wherein the first display device is disposed such that a screen of the first display device is visible to an operator of a Point of Sales terminal.

16. The display control method according to claim 13, wherein the second display device is disposed such that a screen of the second display device is visible to a customer.
